(19) United States
(12) Patent Application Publication
(10) Pub. No.: US 2011/0173122 A1
(43) Pub. Date: Jul. 14, 2011

(54) Systems and methods of bank security in online commerce

(76) Inventor: Tara Chand Singhal, Torrance, CA (US)

(21) Appl. No.: 12/655,848

(22) Filed: Jan. 9, 2010

(51) Int. Cl. G06Q 40/00

(52) U.S. Cl. 705/44

(57) ABSTRACT

A system of bank security for reducing fraud losses due to unauthorized transactions in online commerce has a mobile authorization service (MAS) system with interfaces with a financial institution's computer systems that maintain customer's accounts and mobile wireless devices of the customers. The MAS system enables authorizations, of payment authorization requests that are received for payment on the account of the customers that are maintained at the financial institution, by the customers themselves in real time, before authorizing such payment transaction requests by the financial institution. The MAS system authorizes payment on those payment authorization request transactions that are on a pre-authorized transaction list and for those transaction that are not on the list, the transaction is authorized by a secure mobile contact means with the customer, thereby reducing payment on transaction that have not been authorized and thus reducing bank's fraud losses.

### CROSS REFERENCE TO RELATED APPLICATIONS

This application is related to and claims priority on U.S. application Ser. No. 12/384,718 titled “System of Security That Prevents Abuse of Identity Data in Global Commerce via Mobile Wireless Authorizations” filed on Apr. 08, 2009, by Tara Chand Singhal. The contents of U.S. application Ser. No. 12/384,718 are incorporated herein by reference.

### FIELD OF THE INVENTION

The preferred embodiment is for systems and methods of bank security for reducing fraud losses due to unauthorized transactions in online commerce via mobile wireless authorizations by the customer.

### BACKGROUND

The global commerce using electronic global computer networks relies on use of identity data for a range of identity data driven transactions such as, payment request on checking accounts via checks and equivalent debit cards from payees, and payment request via credit cards from merchants via their point of sale systems.

In such identity data driven transactions, the identity data owner's identity data is pre-stored in the transaction processing entity systems and is used when the identity data driven transactions are initiated by the transaction initiating entities for the identity data owner. The identity data owner is remote from the transaction processing entity and it is extremely difficult if not impossible for them to verify the authenticity of the transaction, as initiated by a transaction initiating entity. Others can and do initiate transactions by impersonating the identity data owner by theft of Id data and then abusing and misusing the identity data.

The impact of the theft of identity data and misuse and abuse of the identity data by others, on the id data owner, the banks, and the merchants is described in the following two news stories. One story highlights the impact of id theft on online commerce and the other story highlights the impact on the victims of identity theft.

Due to the high rate of returns and fraud online businesses that conduct B2C transactions on the Internet pay a premium for processing fees. This premium is usually 20% higher than their offline counterparts. There is also an additional reserve fee, which is temporarily withheld from each transaction (3-5% up to 30 days). Why are these fees so high, in comparison to offline transactions? The main reason is that security is “reduced” due to the lack of physical presence and identity verification by the online merchant. Identity theft and fraud are easier to commit online.

Currently online credit card fraud rates are three times higher than off-line transactions. CNP, card not present transactions leverage the same processing infrastructure as regular in-person credit card transactions. Once the transaction information is passed through the “gateway” payment processor, the transaction is processed using the same ETF/ACH rules as other electronic transfers. Therefore the focus of security and privacy policy must be on the “front-end” of the transaction. Security, authentication and privacy protection must be strong at the point of sale, the merchant web site.

The worst issue for a vendor is to deal with re “unexplained” charges to a customer's account. These issues not only cost the vendor money and time to resolve. They erode customer confidence and damage the customer relationship.

As another news story for illustration of the impact of the identity theft on victims is from LA Times by Patti Morrison, titled, Identity theft hits close to home, March 12, 2009. When someone steals your mail, it's a whole new worrisome world. Add me to the thousands of victims of identity theft (313,982 reported last year, according to the Federal Trade Commission). Although in my case, it's still potential identity theft, and I′m spending a lot of time and money to keep it that way.

Last week, someone drilled the lock out of my mailbox and stole what was inside: the usual magazines and fliers, and a financial statement. Last year, I bought the locking box because of mail theft. Cops had stopped a truck loaded with stolen mail nearby. A thief swiped an unsolicited preprinted credit-card-with-checks envelope from a neighbor's box and went on a spending spree.

Now my mailbox is gaping open like Jerry Lewis' jaw. The irony is that I am pretty scrupulous about the personal numbers I flash around. I do no online banking —zero. My online shopping is confined to airline tickets, on a separate credit card. I pay cash for gas and everyday shopping.

So here all my precautions get undone by a thuggish break-and-enter mail theft. It has meant hours on the phone. I called the Postal Inspection Service, the CSI of the USPS, to report the break-in. “We've been getting so many reports about mail theft,” one woman commiserated. I called my local post office to talk to the manager and to stop home mail delivery.

I called my credit card registry for one-call card cancellation. I called the credit union and the American Express credit monitoring service I'd signed up for a while ago. I went to my bank. I called Social Security, but they don't take reports on these matters. Only in extreme cases can you change your Social Security number—like going into the federal witness protection program.

Jonathan Fairtlough is assistant head deputy of the high-tech crimes division at the L.A. County D.A.'s office. Years ago, identity fraud wasn't taken too seriously. Now California has “some great laws,” he tells me. There are slicker means of identity theft than mailbox break-ins, Fairtlough said. Skimming devices slipped into debit and credit card pay points at gas stations, or even in bank ATMs, snag your account and PIN. The thieves make fake cards and clean you out.

At the Sheriffs Department, Sgt. Bob Berardi is part of the identity theft detail. He apologized if he was talking too much—“I'm Italian”—but he had a lot to say. “It's very hard for most people to understand how devastating this can be. . . . The psychological effect stays with you forever. Someone has burglarized you, taken something from you, forced themselves into your life, and you have no idea what that impact is going to be, today, tomorrow or down the road.”

Some matters are out of our control. Ask the poor clients of a Corona del Mar mortgage broker whose files ended up sitting out in the open at a recycling center last month—Social Security numbers, tax returns and all.

Berardi suggests you use your ATM card as a credit, not a debit card. That keeps your PIN from thieves. Make sure your computer security software is up to date. Don't fall for scams; that e-mail that looks like it came from your bank probably didn't. Pretend you're Oliver North and shred everything. Checking your credit is a wearisome task, but do it. I'll be doing it probably every week now—not for three months but for a year or more, because, as Fairtlough told me, thieves will wait until your vigilance slackens.

In the meantime, you business people and bureaucrats of the world, if someone purporting to be me tries to buy a Hummer, or if my name shows up on a passport in Peshawar—well, that is just so not me. Patti Morrison: Accept no substitutes.

When the identity data is so abused and misused, the bank, the data keeping entity, and the identity data owner all suffer adverse consequences. These adverse consequences include financial loss to the bank, loss to the vendor, loss of reputation, and the task of cleaning up the credit profile and reputation for the identity data owners at considerable trouble and expense.

Some banks use fraud monitoring systems based on the spending profile of their customer and contact the customer by telephone. Some service providers monitor credit profile for unusual transactions. While, some choose to lock the release of credit profile data entirely, for those whose identity data, is stolen or being suspected of having been stolen.

The current approaches of preventing misuse of the identity data are insufficient and mostly apply after the transaction has already occurred causing losses for the banks, losses to the vendors, and has created problems in cleaning up credit reputation for the identity data owners. Hence, better systems and approaches are needed.

It is the objective of the preferred embodiment to have the transaction processing entities have a system of authorization of the transaction from the identity data owner themselves before processing the transaction.

It is yet another objective of the preferred embodiment to prevent unauthorized identity data transactions of the identity data owner in payment driven transactions in global commerce.

### SUMMARY

In global commerce, there are many identity data driven transactions that depend upon the use of some one's personal identity data. Many of these transactions are for payment transactions from a person's, credit card, debit card, and checking account that are maintained at a financial institution.

The personal data is stored in computers of banks, merchants and governments and also data service providers who collect and aggregate data from multiple sources and sell to the government and businesses. Based on the pervasive news stories, large quantities of id data have already been stolen, and it is perceived as a matter of time before it is misused or abused, at an uncertain future time, making the theft of such data like a ticking time bomb for those whose identity data has been stolen or believed stolen.

One solution to protect against such theft of id data and the potential abuse and misuse is that the card issuing industry replaces the account numbers and issues new cards at their considerable expense. Another solution has been that the card issuing industry uses fraud alert systems based on a customer profile, where a transaction based on such a profile is flagged for human intervention by a banks' automated fraud agent. As yet another solution, the id data owner is told to monitor his/her credit profile for unauthorized transactions or requests for data.

Based on a large number of news stories, it has become easy for the-thieves to misuse someone else's id data in a variety of ways. The preferred embodiment herein describes a system and method, that even after such id data is stolen the systems and method would prevent misuse and abuse of such id data.

In the system of the preferred embodiment, a system of bank security for reducing fraud losses due to unauthorized transactions in online commerce has a mobile authorization service (MAS) system with interfaces with (i) a financial institution's computer systems that maintain customer's accounts and (ii) mobile wireless devices of the customers via a wireless network interface. The MAS system enables authorizations, by the customers themselves using their wireless mobile devices, of payment authorization requests that are received for payment out from the customers' accounts that are maintained at the financial institution, before the financial institution authorizes such payment transaction requests, thereby reducing bank's fraud losses in online commerce.

The system uses and leverages the wide availability of mobile phones to contact their owners in real time via an SMS message for authorization of the identity data driven transaction. The system of security for identity data, using the mobile device authorization system may obviate the need for authorizations for the identity data driven transaction at the transaction initiating entities that require a signature, and additionally a proof of identity; as such approaches are not entirely satisfactory being dependent upon a merchant clerk to verify identity.

There are various modalities in how the MAS system may be used to work within the existing systems. In the system of security for identity data, a mobile authorization service provider may manage a database of mobile contact information and the corresponding mapping of identity data and provides a service to the transaction processing entities that facilitates the contact with the identity data owner for the authorizations. Alternatively, the transaction processing entity may themselves manage the mobile contact information.

The contact by the transaction processing entity or the mobile authorization service provider via the owner's wireless mobile communication device may include a SMS text message that embeds a pre-placed security code and may include sending to the identity data owner, (i) name of the transaction initiating entity, date and time, and an amount for a payment transaction. The authorization may include accept, decline or time out due to lack of response, where the time out is set based on the type of the transaction. The system logs an authorization event in an event log database for use as an authorization record of the transaction.

The system may be operated as an optional fee based service for those identity data owners who wish to prevent unauthorized transaction using their identity data. Such an optional fee based system may have a service choice flag maintained in the data base of the transaction processing entities based on the request of their customers.

These and other aspects and features of the system that prevents abuse and misuse of identity data of an identity data owner in identity data driven transactions is described in detail with the help of accompanying drawings.

### BRIEF DESCRIPTION OF THE DRAWINGS

Some of the novel features of this preferred embodiment will be best understood from the accompanying drawings, taken in conjunction with the accompanying description, in which similar reference characters refer to similar parts, and in which:

FIG. 1 is a block diagram that illustrates features of the present preferred embodiment of a mobile authorization service system for payment authorizations.

FIG. 2 is a block diagram that illustrates features of the present preferred embodiment of a mobile authorization service system for payment authorizations.

FIG. 3 is a block diagram that illustrates features of the present preferred embodiment of the mobile authorization service.

FIG. 4 is block diagrams that illustrates databases that may be used for the present preferred embodiment of mobile authorization service system.

FIG. 5 is a block diagram that illustrates databases that may be used for the present preferred embodiment of mobile authorization service system.

FIG. 6 is a data flow diagram that illustrates features of the present preferred embodiment of a mobile authorization service system.

FIG. 7 is a method diagram that illustrates features of an embodiment of a mobile authorization service system.

FIG. 8A is method diagram that illustrate features of the present preferred embodiment of a mobile authorization service system.

FIGS. 8B is method diagram that illustrate features of the present preferred embodiment of a mobile authorization service system.

FIG. 9 is a block diagram that illustrates features of the present preferred embodiment of a mobile authorization service system.

FIG. 10 is a block diagram that illustrates features of an embodiment of a mobile authorization service system.

### DESCRIPTION

### Introduction

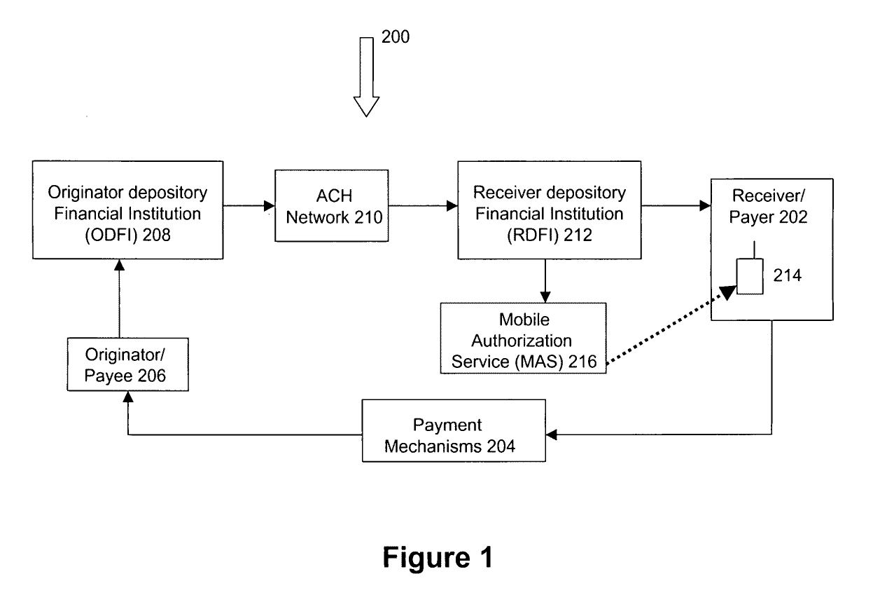

With reference to FIG. 1, an Automated Clearing House (ACH) financial transaction system 200 provides for a payer 202 (receiver in the ACH terminology), who by a payment mechanism 204 that may include a variety of forms, such as checks and bankcards, pays a payee 206, a merchant or a private party or service provider, (called originator in ACH terminology). The originator 206 with the financial data of the payee contacts his/her ODFI 208, who via the ACH network protocol 210 submits the transaction to the RDFI 212, the payer's bank, to authorize the transaction. The RDFI 212 verifies availability of the funds from the payer 202 account and sends a payment authorization or rejection as appropriate to the ODFI 208. The ODFI communicates such payment authorizations or rejections to the originator 206.

The RDFI 212 sends periodic account statements to the payer 202 by US mail or online banking means. The ACH rules, for the ODFI 208, require that the originator 206 have a written or verbal authorization for the transaction from the payer 202.

This payment authorization system 200 requires an RDFI 212 to approve a payment relying solely on the ability of the originator 206 to have genuine authorizations from the payer 202. Based on published news items on identity data related fraud, anyone may impersonate and provide fraudulent authorizations on behalf of the payer 202, both for remote authorizations and in person authorizations, enabling payment to be authorized from his/her account without his/her knowledge.

The embodiment, as illustrated in FIG. 1, described here for preventing abuse and misuse of the identity data, related to bank data in this situation, has a mobile authorization service (MAS) 216 that is contacted by the RDFI 212 to obtain real time authorization of the transaction from the payer 202 via his/her wireless mobile device 214.

### Mobile Authorization Service (MAS) System 30

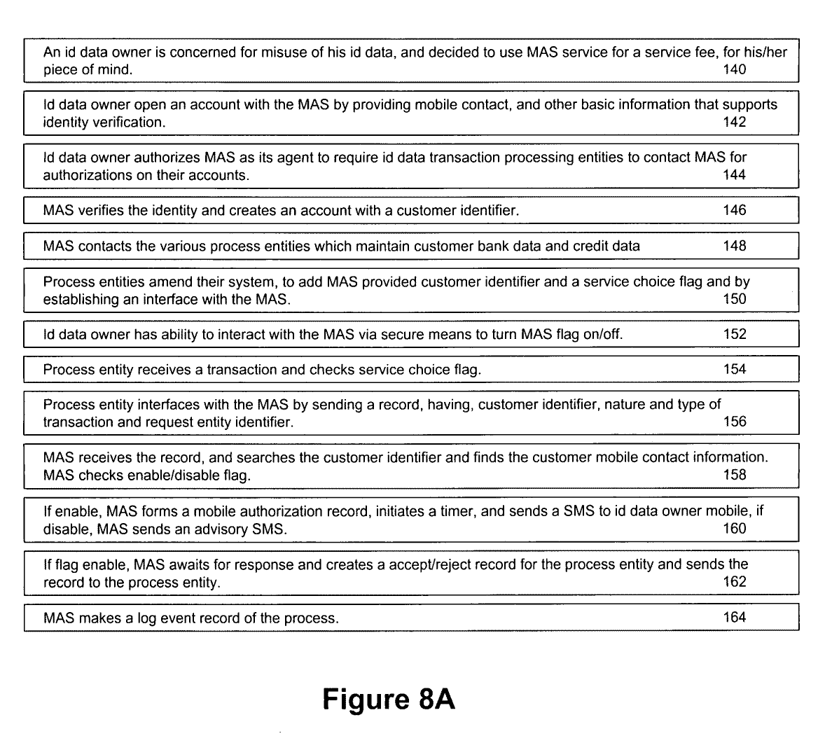

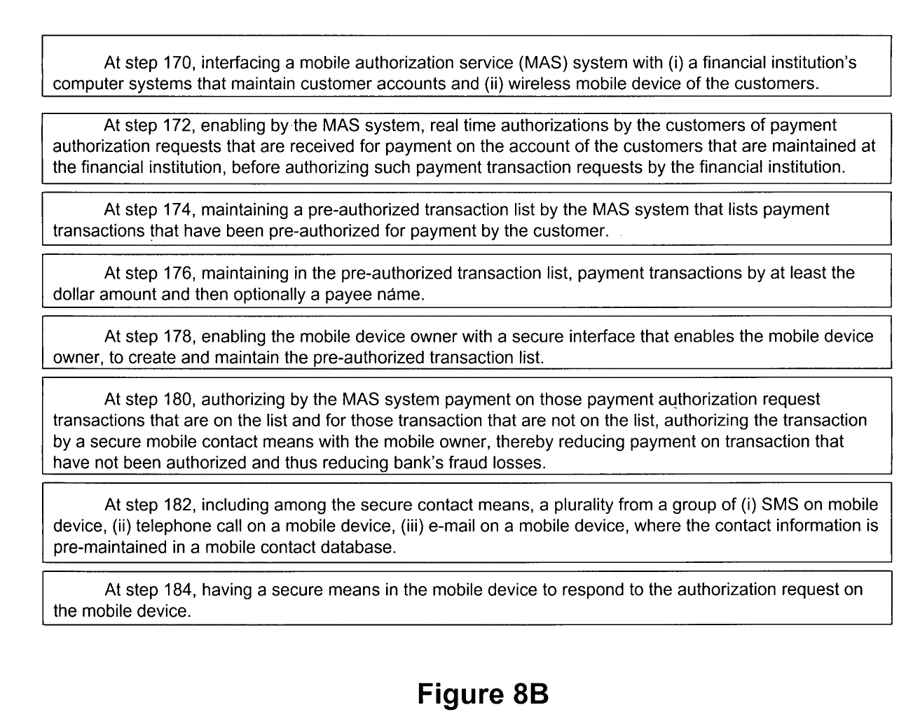

In implementing such a mobile authorization system, an id data owner, concerned for misuse of his id data, for his/her piece of mind decides to use MAS service for a service fee. The method steps for using MAS are described later in detail with reference to FIG. 8A. They are summarized here. The id data owner opens an account with the MAS by providing mobile contact information, and other basic information that supports identity verification. The id data owners authorize MAS as their agent to require id data transaction processing entities, RDFI 212, as in FIG. 1, to contact MAS 216 for authorizations on their accounts.

MAS verifies the identity and creates an account with a customer identifier. MAS contacts the various transaction processing entities which maintain customer bank data RDFI 212. As a result of this request, the entities 212 amend their system by (i) adding in their databases, the MAS provided customer identifier and a service choice flag to facilitate identifying those who have chosen this service and those who have not, and (ii) by establishing an interface with the MAS.

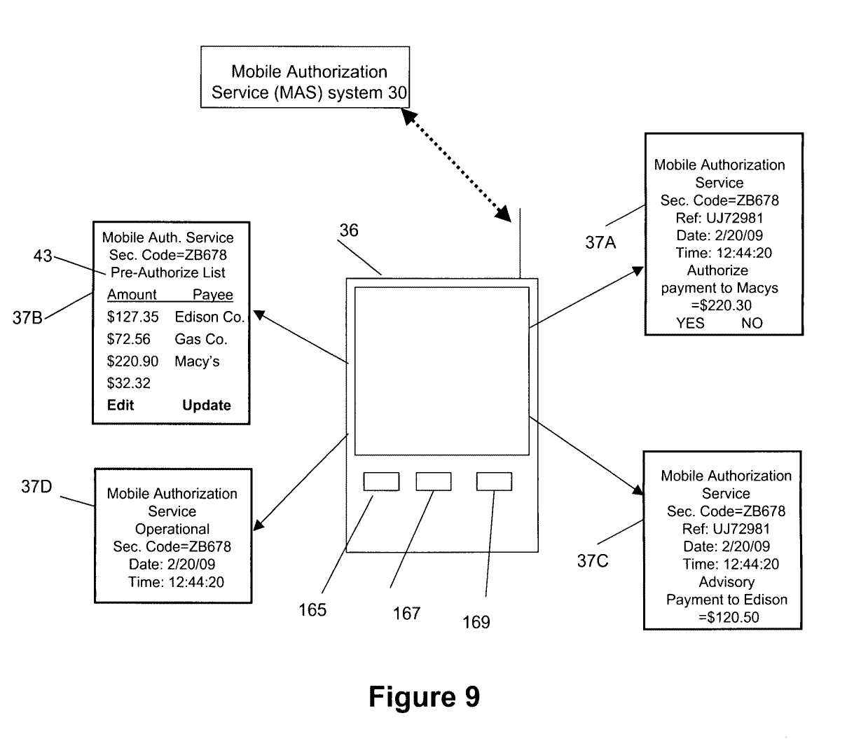

As described later with reference to FIG. 9, the id data owner is provided the ability to interact with the MAS via secure means to turn a MAS enable flag on/off that enables the real time mobile authorizations to be turned off and on for reasons as described later in here. Prior art provides means for such secure means.

The RDFI 212 receives a transaction request and checks the status of the service choice flag in their databases. When the MAS service choice flag is set to yes, the transaction processing entities 212 in FIG. 1 interface with the MAS 216 and send an authorization request record. The authorization request record may have a customer identifier, nature and type of transaction, and originator name. MAS 216 receives the authorization request record and searches the customer identifier in its database and finds the corresponding customer mobile contact information. MAS checks in its database, the status of the authorization service enable/disable flag. If the flag is set to enable, MAS forms a mobile authorization short messaging system (SMS) protocol based text message, initiates a timer, and sends the SMS to the id data owner's wireless mobile device. If the flag is set to disable, MAS may send an advisory SMS related to the transaction or not send anything, based on customer preference. If flag is set to enable, MAS then waits for an accept/reject return response and then creates an accept/reject record for the transaction processing entity 212 and sends the accept/reject record to the transaction processing entity 212. MAS 216 make a log event record of the authorization process.

A service fee may be charged for this service to support the operation of the MAS. The service fee may range in the five to fifteen dollars per month for this service and it is believed, such a service fee would be reasonable for the service of preventing abuse and misuse of id data owner's identity data. Such a flat fee or a fee based on per transaction may be charged from the identity data owner. Such a fee for this type of service for the benefits provided is considered reasonable based on similar fees being charged by other service providers who monitor credit profiles for suspicious activities. A part of this service fee may be shared with the RDFI for their cooperation in amending their systems to interface with the MAS.

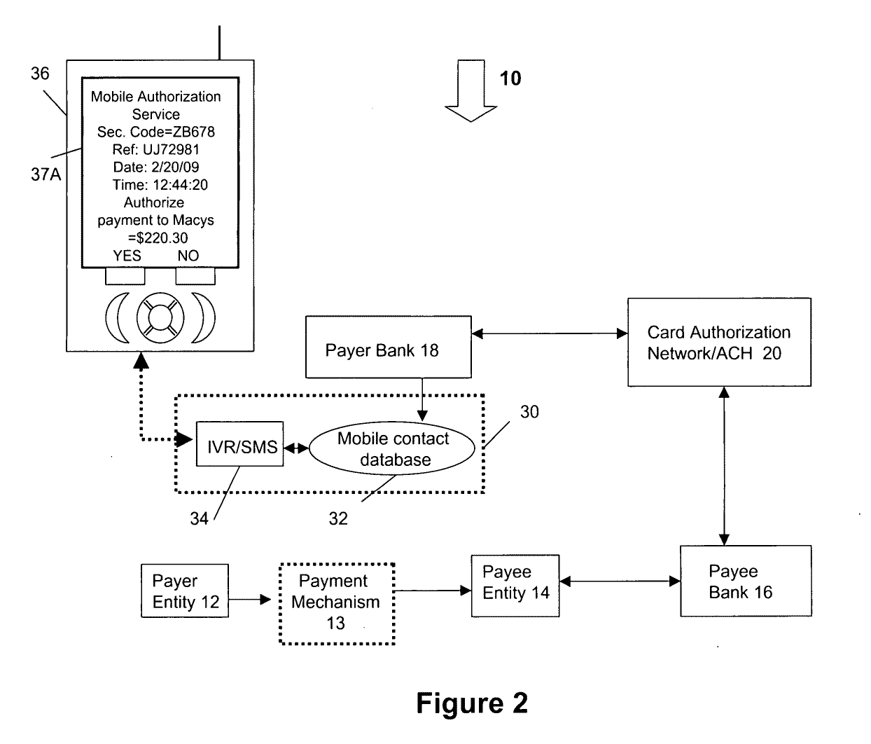

A mobile authorization service customer may have multiple accounts with multiple financial entities. In a preferred embodiment, as illustrated in FIG. 2, a central MAS 30, in lieu of MAS 216 may service all of these processing entities, as it would be more efficient for the customer to have one mobile authorization service, service all of his/her accounts. It would also be more efficient for the processing entities to have one mobile authorization service, instead of building and maintaining their own systems. Alternatively due to business and competitive reasons, large financial institutions, each of them may choose to offer their individual mobile authorization service to their customers.

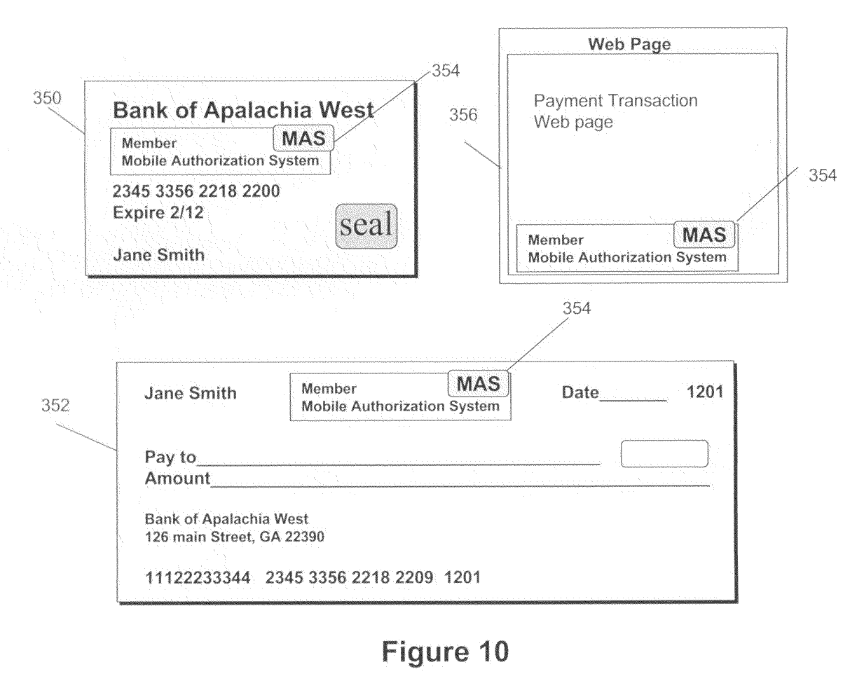

In addition, optionally, as illustrated in FIG. 10, the financial entities or web service providers may want to advertise the applicability and availability of the mobile authorization service 30. The advertisement may be by putting a MAS notation and a logo symbol 354 on a bankcard 350, a check 352, and a web page 356. Such a display of the MAS would indicate to the consumers of the financial entities and the web page merchants that an account with them is protected against fraudulent misuse by MAS 30. These and other aspects of the embodiments are described here in detail.

As illustrated with the help of FIGS. 2, a system of security 10 that prevent misuse or abuse of identity data in identity data driven transaction in global commerce via a mobile authorization service is described.

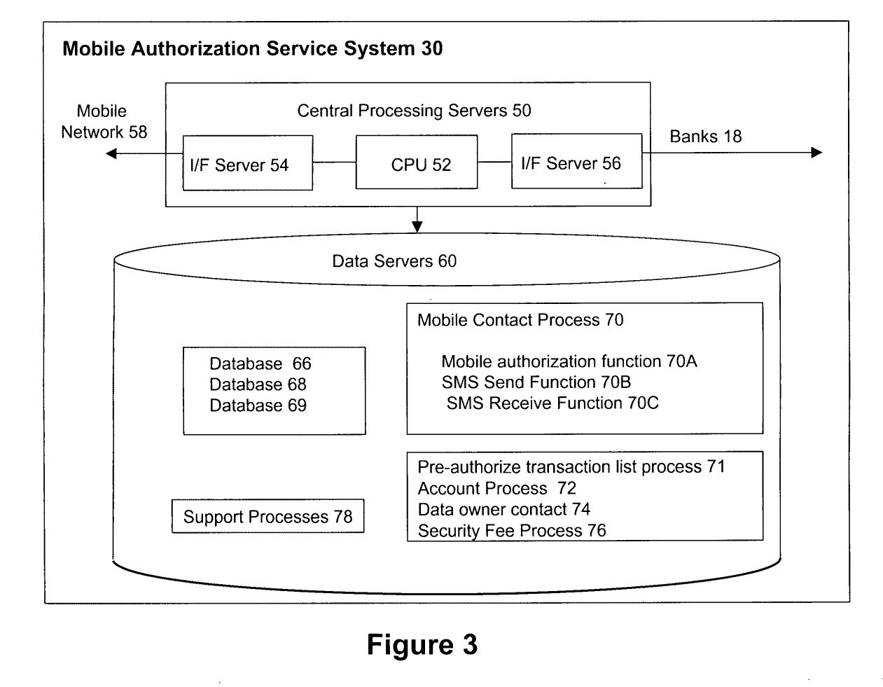

As shown in FIGS. 2 and 3, a system 10 of bank security for reducing fraud losses due to unauthorized transactions in online commerce has a mobile authorization service (MAS) 30 system with interfaces with (i) a financial institution's computer systems 18 that maintain customer's accounts and (ii) mobile wireless devices 36 of the customers via a wireless network interface 58.

The MAS 30 system enables authorizations, by the customers themselves using their wireless mobile devices 36, of payment authorization requests that are received for payment out from the customer's accounts that are maintained at the financial institution 18, before the financial institution 18 authorizes such payment transaction requests, thereby reducing bank's fraud losses in online commerce.

The system 10 as described with reference to FIG. 2 is for those identity data driven transactions that require a financial bank entity that is custodian of a customer's bank accounts to process a request for payment from the customer's bank accounts.

With reference to FIG. 2, the system of security 10 prevents misuse of identity data of an identity data owner, where an identity data owner and also a payer entity 12, via a payment mechanism 13, such as, a bankcard or a check, submits to a payee entity 14, such as a merchant or a payee, in an identity data driven transaction, the identity data of payer 12, in a global commerce network. The payee's bank 16 receives the identity data, and as the transaction requesting entity sends the request for a payment authorization via a card authorization network or an automated clearing house 20, to the payer's bank 18, the transaction processing entity.

The payer's bank 18, the transaction processing entity, while processing this request for payment or payment authorization puts the request on hold for a brief period of time, and via a mobile authorization system 30, that has a mobile contact database 32 and IVR/SMS subsystem 34, sends a request for authorization of the transaction to the mobile device 36 of the identity data owner, or payer entity 12.

The device 36, displays a Mobile Authorization Service message 37A that may have a security code, a reference number, date and time, and seeks authorization of a specific transaction via a Yes or No or accept/reject response.

### Payment Transaction Protocols

A number of prior art protocols and electronic networks facilitate the electronic communication between banks such as the financial transaction originating entity and the receiving bank entity where an account is maintained. There are three different protocols and networks that facilitate the transfer of funds for payment transactions between the originating and receiving financial entities. They are ACH, electronic private network (EPN) and the credit card network.

ACH is provided by Federal bank, EPN is a private operated network and card authorization network is also a private network between card issuing banks. In addition, for debit card transactions, there are one or more EFT networks, operated by private entities. They all operate similarly, where a receiving bank receives a request record for payment authorization of a credit or debit transaction for the account of customers for which it maintains accounts. The receiving bank, upon receiving a payment transaction authorization request record, first checks to see if it can approve the transaction. For example, the receiving bank can reject a transaction if there are insufficient funds to cover the request and also if there is a stop order that has been placed against a particular check. The receiving bank then either accepts or rejects the transaction by using the communication protocol. The protocol enables the rejected transaction to be resubmitted again two times.

Automated Clearing House (ACH) is an electronic network for financial transactions in the United States. ACH processes large volumes of both credit and debit transactions, which are originated in batches. Rules and regulations governing the ACH network are established by NACHA—The Electronic Payments Association (formerly the National Automated Clearing House Association) and the Federal Reserve (Fed).

The operation of ACH is described in detail here for the benefit of the reader. ACH is managed by the NACHA operating rules, which provide for the inter-bank clearing of electronic payments for participating depository financial institutions. The Federal Reserve and Electronic Payments Network act as ACH operators or central clearing facilities through which financial institutions transmit or receive ACH entries.

As illustrated in FIG. 1, in ACH, an originator 206, which can be an individual or entity, submits a transaction to an Originator 208. The originator 208 is an Originating Depository Financial Institution (ODFI) is a participating financial institution that originates ACH entries at the request of and by ODFI agreement with its customers. ODFI's must abide by the provisions of the NACHA Operating Rules and Guidelines.

Receiving Depository Financial Institution (RDFI) 212 is any financial institution qualified to receive ACH entries that agrees to abide by the NACHA Operating Rules and Guidelines. Receiver 202 is an individual, corporation or other entity that has authorized an Originator 206 to initiate a credit or debit entry to a transaction account held at an RDFI 212.

In accordance to the ACH 210 process, with the rules and regulations of ACH, no financial institution may simply issue an ACH transaction (whether it be a debit or credit) towards an account without prior authorization from the account holder (known as the Receiver 202 in ACH terminology).

An ACH entry starts with a Receiver 202 authorizing an Originator 206 to issue ACH debit or credit to an account. An Originator 206 can be a person or a company (such as the gas company, a local cable company, or one's employer). Depending on the ACH transaction, the Originator 206 must receive written (ARC, POP, PPD), verbal (TEL), or electronic (WEB) authorization 204 from the Receiver 202. Written authorization constitutes a signed form giving consent on the amount, date, or even frequency of the transaction. Verbal authorization needs to be either audio recorded or the “Originator” 206 must send a receipt of the transaction details before or on the date of the transaction. A WEB authorization must include a customer reading the terms of the agreement and typing or selecting some form of an “I agree” statement.

Once authorization is acquired, the Originator 206 then creates an ACH entry to be given to an Originating Depository Financial Institution (ODFI) 208, which can be any financial institution that does ACH 210 origination. This ACH entry is then sent to an ACH 210 Operator (usually the Fed) and is passed on to the Receiving Depository Financial Institution (RDFI) 212, where the Receiver's 202 account is issued either a credit or debit, depending on the ACH transaction.

The RDFI 212 may, however, reject the ACH transaction and return it to the ODFI 208 if, for example, the account had insufficient funds or the account holder indicated that the transaction was unauthorized. An RDFI 212 has a prescribed amount of time in which to perform returns, ranging from 2 to 60 days from the receipt of the ACH transaction. However, the majority of returned transactions are completed within 24 hours from midnight of the day the RDFI 212 receives the transaction.

An ODFI 208 receiving a return of an ACH entry may re-present the ACH entry two more times (three attempts is the maximum allowed) for settlement. Again, the RDFI 212 may reject the transaction, after which, the ODFI 208 may no longer re-present the transaction via the ACH 210.

As described above, the ACH 210 protocol already provides for acceptance or rejection by the receiving bank 212. Further the ACH protocol provides for resubmission of the same transaction by the originator 208, if it was rejected less than two times, enabling a final rejection on the third attempt. The originator 206 is required by law to initiate the transaction only when it has a written authorization. Further the actual bank transfers happen later in time within twenty four hours. As safety measures, in ACH the originator 206 or receiver 202 has up to 60 days to question a transaction on his/her account bank statement.

Such a protocol as ACH 210 may optionally be enhanced to communicate a predefined time delay in acceptance or delayed acceptance, in addition to acceptance and rejection of the transaction immediately by the receiving bank, allowing the receiving bank to seek an authorization by the true identity data owner, the bank account owner. The protocol may indicate that the approval is delayed depending upon the type of the transaction for an authorization beyond checking sufficiency of funds or other issues such as stop payment. The protocol may be based on using the current rejection protocol by adding a time delay to resubmit the transaction. Similar protocols exist in ACH such as one that communicates a stop payment order or insufficient funds as part of the rejection.

As a simplified illustration, when the transaction is first submitted, it may be rejected with a field to indicate that the transaction may be resubmitted a predefined time later. The predefined time may be specified in seconds, or minutes or hours, where such a pre-defined time would be used for a mobile authorization from the identity data owner via the mobile authorization service 30.

Hence depending upon the type of the transaction, real time and almost real time, mobile wireless based authorizations can be obtained from the id data owner. The time it takes the receiving bank to check the status of the flags and send a SMS message is in seconds, and assuming 5 seconds for authorization, the mobile authorization service can provide an authorization within 10 seconds where the authorizer is waiting for the authorization to occur. Where the authorizer is not waiting, the authorization may be delayed by up to 18 hours for next day approval.

Further, the protocol in Internet type computer networks are based on state based transactions and can keep a transaction pending until authorization is obtained or not obtained and then issue an acceptance or rejection as appropriate. For that, a time out limit may be implemented by the ODFI and may be appropriately set. The other two networks, EPN and card authorization networks operate similarly using similar protocols.

### Mobile Authorization Service (MAS) System 30

The MAS 30 by providing real time authorizations provides for safety measures that does not exist in the prior art payment systems, where unauthorized transactions are handled after they have occurred and are handled manually by the customer receiving a bank statement, reviewing the statement, and then questioning a transaction with his/her bank.

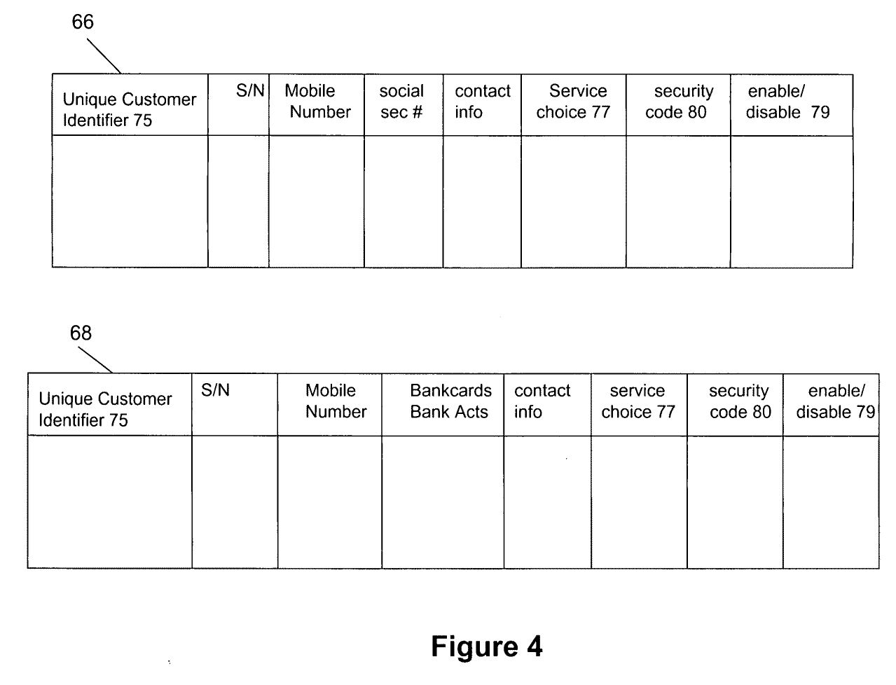

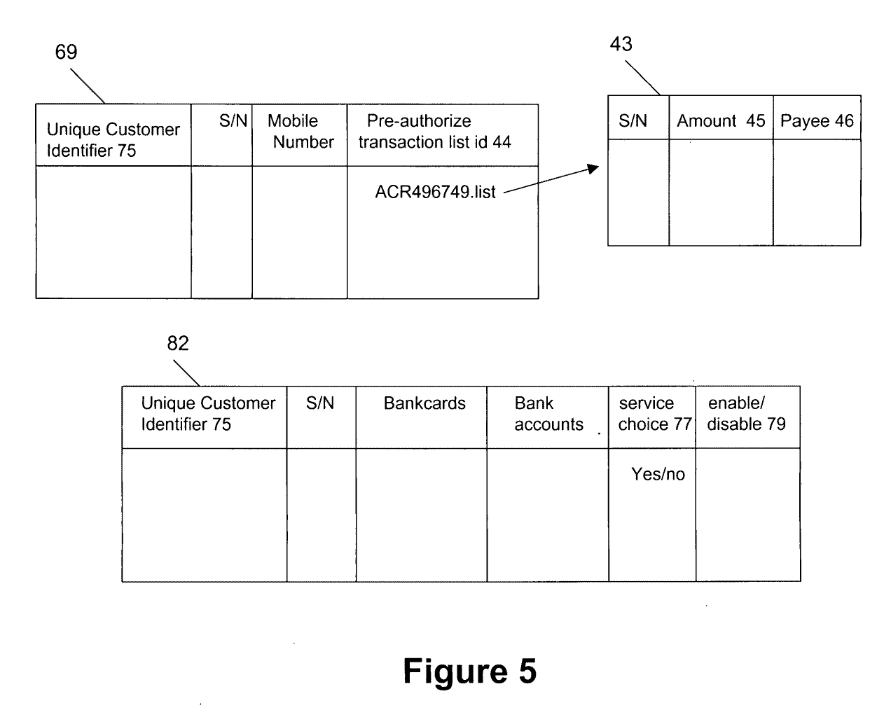

A financial transaction processing entity such as the card issuing bank, may on a request of their customer, and an identity data owner, create a service choice flag, that any request for payment from his/her accounts be authorized by him/her via the mobile authorization service. The flag as a service choice flag providing the option of having this mobile authorization service is described later with reference to FIGS. 4 and 5. When a request for payment is received by the bank, the bank would check this service choice flag and if the flag is set, send a SMS either itself or through a MAS 30 service provider for real time authorization of the transaction to the identity data owner's mobile device 36.

With reference to FIGS. 4 and 5, there may be two different flags in the bank's database. One flag, as described earlier called service choice flag 77, would be used to identify whether a particular customer has chosen to use the MAS 30 or not. A second flag, called enable/disable flag 79, allows the customer that has chosen to use the MAS 30, to enable or disable the MAS for periods of time based on the different modes of use as described here. The bank customer then has the interface to be able to set and reset the enable/disable flag 79. The enable/disable flag 79 may exist at the service provider provided service 30 or the processing entity, the bank 18, itself.

The operation of the second enable/disable flag 79 may best be understood by the following illustrations that describe a proactive mode, a reactive mode, and a combined mode.

In the pro-active mode, the enable/disable flag 79 is left in the enable state all the time. When a transaction is conducted by the identity data owner, the identity data owner would be aware of the transaction and would respond quickly to the mobile authorization request that would require only a minimum acceptable delay in the processing of the transaction. That delay could be in seconds for payment transactions as the identity data owner would be expecting the SMS for authorization and could respond quickly.

In the reactive mode, the enable/disable flag 79 would be left in the disable mode at all times. When a transaction is conducted, the identity data owner would get a real time transaction advisory message. The id data owner can review these transactions and could reject a transaction from final completion, if he/she sends a reject message before expiration of a certain time limit from the time of the transaction origination. The time limit could be in hours and could be up to 18 hours, as the ACH payment systems provide for an actual fund transfer in 24 hours after the payment authorization.

In the combined mode, that combines the features of the pro-active and the reactive mode, the enable/disable flag 79 would be enabled at all times. When the identity data owner is about to conduct a transaction, the enable/disable flag 79 would be disabled with the help of a function key on his/her mobile device and then enabled again with the help of a function key on the mobile device after the payment transaction has been completed. Alternatively a time limit feature in MAS could enable the enable/disable flag after it has been disabled by the help of the function key. As an illustration of the combined mode, an id data owner goes shopping. Before he/she goes to pay, he/she would press a function key on his/her mobile that would disable the enable/disable flag, allowing the transaction to proceed without the mobile authorization process, while he/she would still get the advisory message.

Then, in this illustration, the transaction would be performed without the mobile authorization step, when the identity data owner is aware of and has initiated an identity data driven transaction. After the transaction is completed, then, the id data owner could press another function key to enable the enable/disable flag 79. Alternatively, the enable/disable flag 79 could be automatically enabled after a time out of, let us say five minutes, without the id data owner have to press the second function key.

The combined mode, it is believed would provide the optimum id data abuse protection, while letting the payment systems work as now without the authorization process and let the authorization process kick in for unauthorized or fraudulent transactions.

In addition, to minimize the use of mobile authorizations, there may be a pre-authorize transaction mode. In the pre-authorize transaction mode, a list of pre-authorized transactions is maintained in the MAS 30. Alternatively, the pre-authorize transaction list may also be maintained in financial institutions or the bank's computer systems. The terms financial institutions and banks have been used interchangeably.

As shown in FIGS. 3 and 5, the MAS 30 system maintains a database 69 with pre-authorized transaction list that lists payment transactions that have been pre-authorized for payment by the customer. As shown in FIG. 5, the database 69 maintains the pre-authorized transaction list id 44 with the list 43 that lists payment transactions by at least the dollar amount 45 and then optionally a payee name 46.

The MAS 30 system has a secure interface that enables the bank's and MAS customers to create and maintain the pre-authorized transaction list 43, using their mobile device 36. As illustrated in FIG. 9, the interface screen 37B on the wireless mobile device 36 illustrates the creation and maintenance of the pre-authorize transaction list 43, showing the amount and optionally the payee name. Interface 37B also provides edit and update features and enables edit and update of the contents of the pre-authorized transaction list 43 that is maintained by the MAS 30 system. The interface 37B for creation and maintenance of pre-authorized transaction list 43 may be managed using SMS protocol. An SMS based interface is preferred due to reasons as stated elsewhere.

The MAS 30 system authorizes payment on those payment authorization request transactions that are on the pre-authorized transaction list 43 and for those transaction that are not on the list, the transaction is authorized by a secure mobile contact means with the customer, as illustrated with the interlace 37A. In either case, the advisory message 37C may still be sent to the mobile device 36.

The secure contact means between the customer and the MAS 30 system are with the help of the mobile device 36 and may include a plurality from a group of (i) SMS on mobile device, (ii) telephone call on a mobile device, and (iii) e-mail on a mobile device, where the contact information is pre-maintained in a mobile contact database.

Also there is a secure means in the mobile device to respond to the authorization request on the mobile device. Security technology to establish and maintain such secure connections is prior art using encryption keys and encryption algorithms.

As a simplified illustration of the use of the pre-authorize transaction list 43 of MAS system 30, the customer, using their wireless mobile device 36 and the device 36's interface 37B with the MAS 30, would create a pre-authorized transaction list 43. The items on pre-authorized transaction list 43 could be from bank checks the customer has written or has electronically authorized through their online banking bill pay service. That is, those payment transactions of which the customer has a prior knowledge of at least the dollar amount of the payment transaction may be put on the pre-authorized transaction list 43.

When the specific payment transaction is received and processed at the customer bank 18, the bank 18 would send the transaction detail to the MAS 30. From the customer unique identifier, the MAS 30 would identify the customer in its database, and then would identify the pre-authorized transaction list 43.

From the list 43, the MAS 30 system would first identify the dollar amount of the transaction, and if that specific dollar amount is present on the pre-authorized transaction list 43, the MAS 30 system would authorize the transaction on the customer's behalf and may send an advisory message 37C to the customer, without the need to seek a real time authorization via the active mode as in interface 37A from the customer. The MAS 30 would then delete that specific transaction item from the list 43.

The payee's names 44 on the list 43 is maintained for the convenience of the customer in remembering and identifying the transactions on the list 43 and are not used in authorizing the transaction by the MAS 30 system. It is believed that identifying the transaction by a dollar amount only provides enough specificity of the transaction on the list 43, as the probability of two transactions having the same dollar amount is very low.

Even if there are two transactions with the same dollar amount they could still each be identified by the same dollar amount on the transaction list 43, without affecting the operation of the pre-authorize transaction mode. As a simplified illustration of this, when there are two different transactions with the same dollar amount of 125.00 each, and when a payment authorization request is received for $125.00, the first of these would be used for pre-authorization and then deleted from the list and when another payment authorization request is received for $125.00, then the second of these would be used for pre-authorization and then deleted from the list.

The pre-authorized list may be maintained by the bank's computer systems. In this embodiment, a system of bank security for reducing fraud losses due to unauthorized transactions in online commerce has databases that maintain account information for bank customers and computer systems on the electronic fund transfer network for receiving a payment authorization request and authorizing real time payment transactions on the customer's bank accounts maintained in the databases.

The bank's databases maintain a pre-authorized transaction list database, which maintains a list of payment transactions by payee and dollar amount that have been pre-authorized by the bank customer, where upon receiving a payment authorization request, if the requested transaction is present in the pre-authorized transaction list, an added means of security is provided for the bank before authorizing the specific payment on the pre-authorized list on the account.

For the bank's computer system, the MAS system has a secure means for the bank customer to create and maintain the pre-authorized list in the bank's computer systems and a secure contact means between the bank and the bank customer. These may also include use of a mobile device 36 of the customer.

For those payment authorization requests that are not on the pre-authorized list, establishing a contact via the secure contact means with the bank customer to seek authorization for the payment authorization request that is not on the list.

The bank authorizes payment on those payment authorization request transactions that are on the pre-authorized transaction list and for those transaction that are not on the list, the transaction is authorized by the secure contact means, thereby reducing payment on transaction that have not been authorized and thus reducing bank's fraud losses.

The secure contact means include a plurality from a group of (i) SMS on mobile device, (ii) telephone call on a mobile device, and (iii) e-mail on a mobile device, where the contact information is pre-maintained in a mobile contact database. The system has a secure means in the mobile device to respond to the authorization request on the mobile device.

The system MAS 30 may also have a ping test mode that would send a test message to the mobile wireless device and receive a return response to verify that the MAS features are in an operational state. The ping test may be run periodically by the MAS 30 or it may be run occasionally by the id data owner to assure him/her that the MAS safety features are operative. The ping test may also be used after the account is set up to assure the id data owner and the MAS that the features of MAS are working, as there is encryption and decryption of the messages that is involved in the SMS messages. A function key on the mobile device may be used for the ping test.

The MAS 30 may not be required or necessary for all transactions, such as transactions for small amounts, such as transactions below $10.00 may not require or use mobile authorization service. In these situations, the bank would not contact the identity data owner. Alternatively such a dollar limit can be implemented in the MAS 30 where the id data owner can determine what that limit would be. Letting the id data owner decide the dollar limit can help stop unnecessary mobile authorization messages, based on how an id data owner uses his/her bankcards.

The MAS 30 is not intended to replace or displace any existing fraud detection system the bank may be using but works in addition to those systems. As the bank's existing systems would be operational for all of their customers, whereas the MAS 30 would be operational for those who have chosen this service and would abide by its operation.

Hence, the system 10 has a transaction processing entity 18 in the form of a payer's bank after receiving the identity data driven transaction from a transaction initiating entity or a payee's bank 16 via ACH 20, puts on hold processing of the transaction for a period of time and via the identity data owner's wireless mobile communication device 36, contacts the identity data owner for authorization of the transaction 37A before the transaction processing may be completed. The mobile authorization may be implemented as defined as three operational modes of a proactive mode, a reactive mode and a combined mode.

The system of security 10 in an identity data driven transaction may include identity data driven transactions from a group of (i) credit card payment, and (ii) bank account payment.

The mobile device authorization service system 30 of the system 10 reduces the need for identity data authorizations for the identity data driven transaction at the transaction initiating entities that require a signature, and additionally a proof of identity.

In another embodiment, where the Mobile Authorization Service (MAS) is independent of the bank, in the role of a service provider to them, the system for a wireless mobile device based authorization security service contacts identity data owners via their wireless mobile devices to authorize identity data driven transactions, while they are being processed by a transaction processing entity, so that in a global commerce network, the system prevents misuse of personal identity data of an identity data owner.

In the system 10, a service provider may manage the mobile authorization service system 30 and may manage a database of mobile contact information 32 and the corresponding mapping of identity data and provides a service to the transaction processing entities that facilitates the contact with the identity data owner for the authorizations.

The authorization contact by the transaction processing entity with the id data owner via the MAS 30 and via the owner's wireless mobile communication device may include a SMS text message. The message may embed a pre-placed security code, so that the identity data owner would know and can assure him/herself that the MAS 30 originated the SMS message. The security code may be an alphanumeric or a personal phrase that is easily recognizable by the id data owner.

The SMSs are the most viable, quickest, stable, and widely used message protocol for such applications as the mobile authorization service. The SMS addressing is tied to the mobile phone number. Such phone numbers are portable and remain same when the mobile device is upgraded or the telephone carrier is switched to another carrier. SMS are global in scope and are in wide spread use globally. However in the future other different or improved protocols may be used and are not ruled out.

The authorization message 37A from the MAS 30 as illustrated in FIG. 2 may include sending to the identity data owner, (i) name of the transaction initiating entity, date and time, and optionally an amount for a payment transaction. The authorization may include accept, reject or time out due to lack of response, where the time out is set based on the type of the transaction. Further the contents of the SMS may be encrypted between the mobile device 36 and the MAS 30 using any number of prior art encryption technologies.

As described earlier, the MAS 30 may have an enable/disable flag 79 that disables the MAS system for periods of time. When the enable/disable flag is disabled, the MAS can let the process entity process the transaction without waiting for an accept/reject message from the mobile authorization service. Further, the system 30 logs an authorization event in an event log database for use as an authorization record of the transaction.

The system 30 has a database of mobile identity that maintains mapping of the mobile contact information with identity data of the identity data owner. The identity data would be from a group of (i) social security number, (ii) bankcards, (iii) bank account numbers, (iv) name, (vi) date of birth, and (vii) zip code. The MAS 30 has a function to receive a request for mobile authorization from a transaction processing entity that would be one from a group of (i) a bank with a bank account information, (ii) a bank with bankcard information, (iii) a credit rating agency, with a social security number, (iv) a medical service provider with name, DOB and zip code, a telephone company, and a similar personal and id data holder.

Alternatively, as illustrated in FIGS. 4 and 5, a unique customer identifier 75 may be used in place of all the customer identity data that may be used to identity the customer in the MAS by the bank, the credit agency or the other data agencies. Then the MAS database would only need to maintain mobile contact information and its mapping to the customer identifier 75, without the need to require and store identity data. A unique customer identifier 75 may be based on some combination of name, address and telephone number, or may be an alphanumeric.

As shown in FIG. 3, the MAS 30 has a mobile contact process 70 that includes a mobile authorization function 70A, a SMS send function 70B, and a SMS receive function 70C.

The mobile authorization function 70A has functions (i) to receive a mobile authorization request from a transaction processing entity, (ii) map the request to an existing record in the database 32 by mapping the identity data or the unique customer identifier, (ii) look up the enable/disable flag status for this particular identity data owner, (iii) then subsequently look up the identity data owner's mobile contact information.

The MAS 30 has a SMS send function 70B (i) to then create an SMS message embedded with the data as 37A for a payment transaction authorization or 37B for a data release authorization, (ii) then optionally encrypt the SMS data with a pre-placed and unique key between the MAS 30 and the mobile device 36, (iii) create a time out counter based on the type of the transaction, and (iv) then send the SMS via the mobile contact information to the mobile device seeking authorization of the transaction.

The MAS 30 also has a SMS receive function 70C (i) to receive a SMS reply response from the mobile device 36 (ii) identify the response by matching the response in the database 32, and (iii) optionally decrypt the response. The system 30 may have a pre-set security code between the mobile device owner and the mobile authorization service to authenticate mobile authorization responses.

The MAS 30 has a mobile authorization function 70A that further provides the functions of, (iv) to then forward the response to the transaction processing entity 18, and (v) create an event log.

The MAS 30 has a pre-authorize transaction list process 71 that provides for the creation and management of the pre-authorize transaction list 43 in database 69 via the interface 37B with the mobile device 36 as illustrated in FIG. 9.

The MAS 30 has an account process 72 that enables an identity data owner to create accounts via the database 32, where the relevant account data would be stored in databases 32. The relevant account data may include, name, address, mobile contact information, payment methods for the service etc. In addition, a similar account process (not shown) may be used to set up an account for the transaction process entities. A separate database may be used for this purpose. Not all databases are shown in FIG. 3.

The MAS 30 may also have data owner contact process 74 that enables the MAS 30 to contact the data owner and to verify the mobile contact information by a number of means such as, audio voice calls, e-mail or ground mail, as well as for creating the security code and pre-placing an encryption key and encryption mechanism.

As illustrated with reference to FIG. 9, the mobile device 36 that works in conjunction with the MAS 30 may have a mobile authorization function that enables the mobile device 36 to be customized to receive SMS authorization request messages from the MAS 30 and be able to respond to such authorization SMSs by function keys. The authorization request message may be for a payment transaction 37A, or it may be for a payment advisory message 37C. The device 36 owner may respond to message types 37A by using a pair of function keys 165 and 169, where the pair of function keys would automatically embed a return SMS with either an accept or reject code, encrypt the SMS and send the SMS to the mobile authorization system 30.

The mobile authorization function of the device 36 may have an additional function key 167 that would disable and then enable the enable/disable flag 79. A function key (not shown) may also be used to perform a ping test by which test messages may be sent and received to and from the MAS 30. The results of the test message 37D would be to confirm to the device 36 owner that the MAS 30 is functional.

As an optimum or simpler solution for some or many id data owners for using the MAS 30, there may be only two function keys on the mobile device 36. One function key would be used to temporarily disable the enable/disable flag 79 before a know transaction is begun or initiated. A time out feature in MAS 30 would again enable the enable/disable flag 79. A second function key would be used for the ping test.

Hence the system of security that prevents misuse of identity data of an identity data owner in an identity data driven transaction in a global commerce network, the system has wireless mobile device 36 of an identity data owner, where the mobile wireless device 36 has security means to securely receive a mobile authorization message requesting authorization of an identity data driven transaction from a mobile authorization service 30. The mobile device 36 has means to reply to the transaction authorization message with either an accept or a reject return response message. Alternatively or in addition the mobile device 36 has means to securely receive transaction advisory messages and be able to timely send stop transaction order messages for those transactions that are unauthorized.

The device 36 has an accept function key and a reject function key, which when activated launches a function in the device to return the appropriate accept and reject response return message.

The system 30 may have a security fee process 76 which is used to levy a fee to support the operation of the MAS 30. The security fee may be levied to the bank and the credit agency for the service of obtaining authorization via a mobile contact of the customer. Alternatively, the system 30 may levy the security process fee directly on the identity data owner, or a combination of both based on the benefit provided to each of them.

As in FIG. 3, a mobile authorization service system 30 has a set of central processing units (CPUs) servers 50 that have a interface server 54 that interfaces with the mobile wireless network 58, interface server 56 that interfaces with the banks 18 and the data agencies 44 via a global network. The interface servers 54 would also provide the subsystems for SMS and interactive voice response (IVR)) that would interface with the wireless cellular telephone network. The CPU servers 50 interface with data servers 60. The data servers 60 maintain database 66, database 68, and database 69, as described with reference to FIG. 4. These databases enable MAS 30 to function as a service provider system. Alternatively, and as described with reference to FIG. 5, when the MAS functions as a captive system for the transaction processing entities, the data servers may maintain databases as table 82. Table 82 would enable the MAS 30 to function as a captive system for each type of transaction processing entity such as for payment transactions.

The data servers 60 also store process programs that execute the functions of the MAS 30. These may include the mobile contact process 70, the pre-authorize transaction list process 71, the account process 72, the data owner contact process 74, and the security fee process 76. Additionally, the support processes 78 supports the overall operation of the mobile authorization service system 30.

As shown in FIG. 2, the MAS 30 also has an IVR/SMS subsystem 34 that interfaces with the wireless network to be able to send and receive SMS messages. The interactive voice response (IVR) system may be used by the identity data owners to set up the account with the MAS 30. Any other method, such as US mail or web transaction may also be used to set up the account.

With reference to FIG. 4, the database 66, maintains data fields of a serial number (S/N), a unique customer identifier 75, a mobile number, optionally a social security number, customer contact information such as name, address etc., a service choice flag 77, an enable/disable flag 79 and a security code 80, where database 66 would support the mobile authorization service for the data release transaction such as credit data agencies, and where the social security number may function as the connecting reference between the credit data agencies own systems that maintain customer data and the MAS 30. Alternatively, the unique customer identifier 75 may also serve as the linking reference, in lieu of the social security number, when the service provider 30 is separate and independent from the credit data agencies. The database may also have a encryption code key (not shown)

Also with reference to FIG. 4, the database 68, maintain data fields of a serial number (S/N), a unique customer identifier 75, a mobile number, optionally bankcards and bank account data, contact information that may include name and address etc., a service choice flag 77, an enable/disable flag 79 and a security code 80, and where database 68 would support the mobile authorization service for the banks, where the bankcard or the bank account number may function as the connecting reference between the banks' own systems that maintain customer data and the MAS 30. Alternatively, the unique customer identifier 75 may also serve as the linking reference, in lieu of the bank account number, when the service provider 30 is separate and independent from the bank. A unique customer identifier 75 would be a preferred choice as it would be the same for a customer irrespective of bank accounts at different banks and credit profile at different credit bureaus.

With reference to FIG. 5, the database 69 would maintain for each account holder a pre-authorized transaction list 43 by list id 44 and the data on the list 43 as payment amount 45 and payee identification 46.

With reference to FIG. 5, a bank 18 would maintain a table 82 that provides for a service choice flag 77 of yes/no anchored to its own customer identifying data of bank account data. The table 82 may also have an enable/disable flag 79, enabling the identity data owner to enable/disable the operation of the mobile authorization service for period of time. Alternatively, the bank may chose to use an independent service provider MAS 30. When the MAS 30 is used, the bank table 82 need not maintain the enable/disable flag 79, as that would be maintained by the MAS 30, as illustrated earlier with reference to FIG. 4.

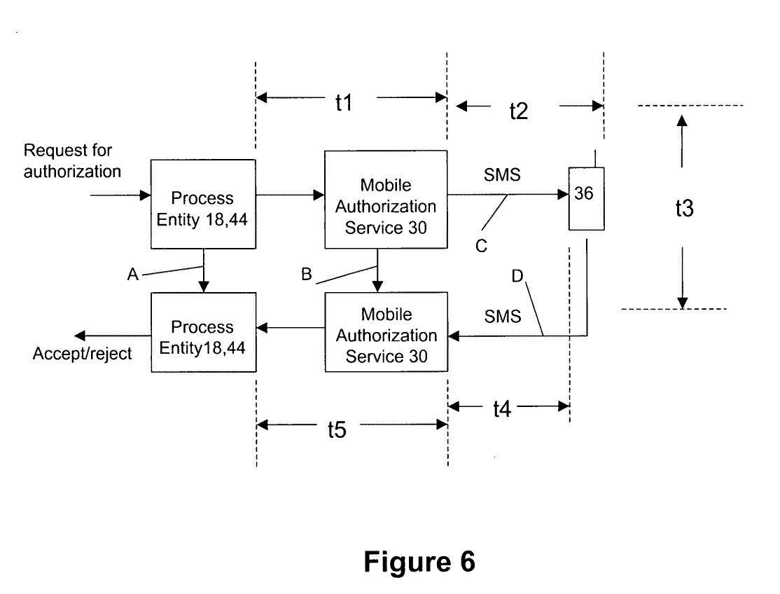

FIG. 6, illustrates the various data flow paths and the use of the service choice flag 77 and the enable/disable flag 79. When a process entity 18 receives a request for authorization, and when the service choice flag 77 is not set, it can check the request and process by itself and send out a accept/reject response as in data path A.

When the service choice flag 77 is set, the process entity 18 sends the request to MAS 30. However, if the dollar amount in a payment transaction is less than a threshold, such as ten dollars, the process entity may not send the request to MAS 30. Also however, if the requestor is a pre-contracted or pre-authorized business, such as a card issuing bank with need to check credit status on a periodic basis or it the payee has an authorized monthly payment account then the process entity 18 may also not send the request to MAS 30. Since the MAS 30 in addition to an authorization system also functions as an advisory system, all transactions may be sent to MAS 30, where MAS 30 can decide which transactions would be advisory to the mobile device owner and which ones would require his/her acceptance of the transaction.

After MAS 30 receives transaction requests from the process entity 18, MAS 30 checks to see if the enable/disable flag 79 is set. If the flag 79 is set enable, then MAS 30 sends out a request to approve the transaction SMS to mobile device 36 via data path C. The mobile device owner views the SMS request and sends accept/reject return SMS via data path D to the MAS 30. The MAS 30 then sends an accept/reject record to the process entity 18.

If the flag 79 in the MAS 30 is disabled, MAS 30 sends an advisory SMS via path C to mobile device owner 36 and also sends an accept response via data path B to the process entity 18.

As illustrated in FIG. 6, it is estimated that the time delay in data flow path A to be the order of a second. The time delay in data path B plus C is t1+t2+t5, it is believed, may be of the order of a second. The time delay in data path C plus D would be (t1 +t2+t3+t4+t5) where t3 is dependent upon the mobile device 36 owner's response. When the mobile device 36 owner is waiting for the authorization request it is estimated for the t3 to be less than five seconds. When the mobile device 36 owner is not waiting for the authorization request, the time t3 may be up to 18 hours, enabling an overnight authorization.

As a simplified illustration, if the id data owner wrote checks and mailed to a business. The business would process the check and then submit them to business's or payee's bank. The payee's bank would then submit them via ACH to the payer or data owner's bank. The payer or receiver bank may process the request in the night time, where the SMS would be sent in the night. So that the mobile device 36 owner can read the SMS the next day and provide an accept/reject authorization. Alternatively, when the bank account payment is via online, the authorization may happen immediately. In either case, the id data owner may choose to use a pre-authorize transaction list 43 feature as described above that would reduce the need for sending SMS messages for real time mobile authorizations.

As has been described earlier, a proactive mode would use the data paths C and D, and a reactive mode would use the data paths B and C. A combined mode would use the data paths B, C, and D, and the combined mode would let the authorized payment transactions to be processed normally without any delay and with an advisory message and would let the fraudulent or unauthorized transactions to be proactively rejected, as they would not be accepted.

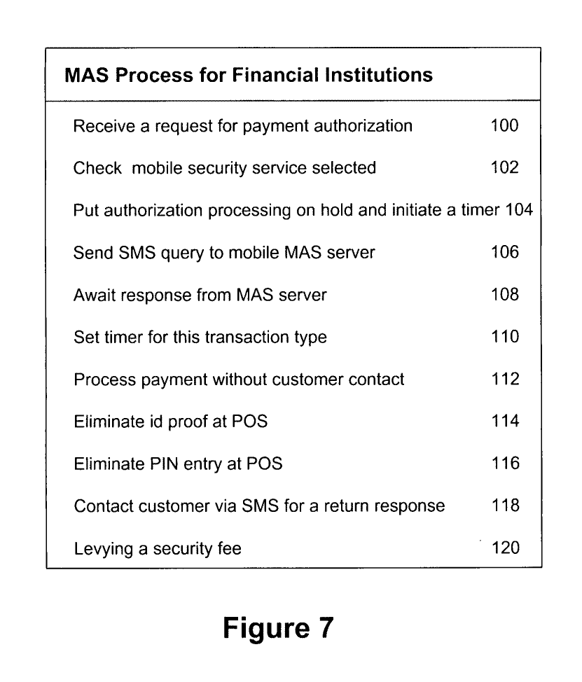

FIG. 7 identifies the method process for mobile authorization process that is managed by the banks themselves. FIG. 8A identifies mobile authorization process that is provided by an independent mobile authorization service 30. FIG. 8B identifies mobile authorization process for an embodiment using pre-authorize transaction lists. As illustrated in FIGS. 7 and 8A-B, the method steps are defined below. Not all steps may be used or used in the order specified.

As in FIG. 7, a method of preventing misuse of bankcard data for an unauthorized payment transaction may have the steps of:

At step 100, receiving, by a financial entity which maintains accounts of a customer, (i) a bankcard originated payment authorization request from a merchant point of sale, via a card authorization network and (ii) a payee originated request for payment via an ACH.

At step 102, check if the identity data owner has selected mobile authorization service by a service flag status.

At step 104, putting on hold, by the financial entity, the processing of the payment authorization request for a period of time enabling contacting the customer via a wireless mobile device of the customer, with information about the payment authorization request and requesting a response with a timer to proceed with the payment authorization;

At step 106, sending the SMS authorization request to the identity data owner via his/her wireless mobile device.

At step 108, awaiting the response by the entity from the customer for a period of time, and processing the response, where on receiving (i) a yes response approving the request, (ii) on receiving a No response declining the request and (iii) for lack of response, advising the requesting entity to present the request at a later time.

At step 110, selecting and setting the period of time of response threshold based on the type of the payment request, the identification of the requesting entity, and originating location of the request, to be between 30 seconds and 18 hours.

At step 112, processing the request for payment without contacting the customer, if the payment amount does not exceed a set amount.

At step 114, eliminating signature and identity proof for a request for payment originating in the form of a credit card transaction;

At step 116, eliminating entry of a PIN for a payment request originating in the form of a check card transaction from a checking account.

At step 118, contacting the customer is in the form of a SMS text message delivered to the mobile phone, requesting a response by pressing a function key, enabling Yes/No response to be automatically sent by the mobile phone, for a return response.

At step 120, levying a security fee for providing the security service of preventing misuse of bankcard, where the fee may be in the form of annual fee or a per transaction fee built into the mobile contact means.

The MAS 30 provides for interfaces and interactions between the id data owner via his/her wireless mobile device 36 and the bank process entity 18. The method steps for these interfaces and actions are described with reference to the method diagram in FIG. 8A. Not all the steps may be used or used in the order as here, are as follows:

At step 140, an identity data owner is concerned for misuse of his id data, and decided to use MAS service for a service fee, for his/her piece of mind.

At step 142, Id data owner opens an account with the MAS by providing mobile contact and other basic information that supports identity verification.

At step 144, Id data owner authorizes MAS as its agent to require id data transaction processing entities to contact MAS for authorizations on his/her accounts.

At step 146, MAS verifies the identity and creates an account with a customer identifier.

At step 148, MAS contacts the various process entities which maintain customer bank data and credit data.

At step 150, Process entities amend their system by adding MAS provided customer identifier, a service choice flag, and by establishing an interface with the MAS.

At step 152, Id data owner has the ability to interact with the MAS via secure means to turn MAS enable/disable flag on/off.

At step 154, process entity receives a transaction and checks service choice flag.

At step 156, process entity interfaces with the MAS by sending a record, having, customer identifier, nature and type of transaction and request entity identification.

At step 158, MAS receives the record, and searches the customer identifier and finds the customer mobile contact information. MAS checks enable/disable flag.

At step 160, if enabled, MAS forms a mobile authorization record, initiates a timer, and sends a SMS to id data owner mobile device. If disabled, MAS sends an advisory SMS.

At step 162, If flag is enable, MAS waits for a return response and creates an accept/reject record for the process entity and sends the record to the process entity.

At step 164, MAS makes a log event record of the process.

As illustrated in FIG. 8B, a method of bank security for reducing fraud losses due to unauthorized transactions in online commerce has the steps of, where all steps may not be used or use in the order specified.

At step 170, interfacing a mobile authorization service (MAS) system with a financial institution's computer systems that maintain customer accounts and with the wireless mobile device of the customers.

At step 172, enabling by the MAS system, real time authorizations by the customers themselves using their wireless mobile devices, of payment authorization requests that are received for payment out from the customers accounts that are maintained at the financial institution, before authorizing such payment transaction requests by the financial institution, thereby reducing bank's fraud losses in online commerce.

At step 174, maintaining a pre-authorized transaction list by the MAS system that lists payment transactions that have been pre-authorized for payment by the customer.

At step 176, maintaining in the pre-authorized transaction list, payment transactions by at least the dollar amount and then optionally a payee name.

At step 178, enabling the mobile device owner with a secure interface that enables the mobile device owner, to create and maintain the pre-authorized transaction list.

At step 180, authorizing by the MAS system payment on those payment authorization request transactions that are on the pre-authorized transaction list and for those transaction that are not on the list, authorizing the transaction by a secure mobile contact means with the mobile owner, thereby reducing payment on transaction that have not been authorized and thus reducing bank's fraud losses.

At step 182, including among the secure contact means, a plurality from a group of (i) SMS on mobile device, telephone call on a mobile device, e-mail on a mobile device, where the contact information is pre-maintained in a mobile contact database.

At step 184, having a secure means in the mobile device to respond to the authorization request on the mobile device.

In summary, the preferred embodiment provides a system of bank security 10 for reducing fraud losses due to unauthorized transactions in online commerce. The system 10 has a mobile authorization service (MAS) system 30 that interfaces with (i) a financial institution's computer systems that maintain customer's accounts and (ii) mobile wireless devices of the customers. The MAS system enables authorizations, by the customers themselves using their wireless mobile devices, of payment authorization requests that are received for payment out from the customers' accounts that are maintained at the financial institution, before the financial institution authorizes such payment transaction requests, thereby reducing bank's fraud losses in online commerce.

While the particular preferred embodiment, as illustrated herein and disclosed in detail is fully capable of obtaining the objective and providing the advantages herein before stated, it is to be understood that it is merely illustrative of the presently preferred embodiments and that no limitations are intended to the details of construction or design herein shown other than as described in the appended claims.

What is claimed is:

1. A system of bank security for reducing fraud losses due to unauthorized transactions in online commerce, comprising:
a. a mobile authorization service (MAS) system with interfaces with (i) a financial institution's computer systems that maintain customer's accounts and (ii) mobile wireless devices of the customers;
b. the MAS system enables authorizations, by the customers themselves using their wireless mobile devices, of payment authorization requests that are received for payment out from the customers accounts that are maintained at the financial institution, before the financial institution authorizes such payment transaction requests, thereby reducing bank's fraud losses in online commerce.

2. The system of bank security in online commerce as in claim 1, comprising:
the MAS system maintains a pre-authorized transaction list that lists payment transactions that have been pre-authorized for payment by the customers.

3. The system of bank security in online commerce as in claim 2, comprising:
the pre-authorized transaction list lists payment transactions by at least the dollar amount and then optionally a payee name.

4. The system of bank security in online commerce as in claim 2, comprising:
the MAS system provides a secure interface that enables the customer, to create and maintain the pre-authorized transaction list.

5. The system of bank security in online commerce, as in claim 2, comprising:
the MAS system authorizes payment on those payment authorization request transactions that are on the pre-authorized transaction list and for those transaction that are not on the list, the transaction is authorized by a secure mobile contact means with the customer, thereby reducing payment on transaction that have not been authorized and thus reducing bank's fraud losses.

6. The system of bank security in online commerce, as in claim 5, comprising:
the secure contact means include a plurality from a group of (i) SMS on mobile device, telephone call on a mobile device, e-mail on a mobile device, where the contact information is pre-maintained in a mobile contact database.

7. The system of bank security in online commerce, as in claim 6, comprising:
a secure means in the wireless mobile device to respond to the authorization request on the mobile device.

8. A method of bank security for reducing fraud losses due to unauthorized transactions in online commerce, comprising the steps of:
a. interfacing a mobile authorization service (MAS) system with (i) a financial institution's computer systems that maintain customer accounts and (ii) wireless mobile device of the customers;
b. enabling by the MAS system, real time authorizations by the customers themselves using their wireless mobile devices of payment authorization requests that are received for payment out from the customers accounts that are maintained at the financial institution, before authorizing such payment transaction requests by the financial institution, thereby reducing bank's fraud losses in online commerce.

9. The method of bank security in online commerce as in claim 8, comprising:
maintaining a pre-authorized transaction list by the MAS system that lists payment transactions that have been pre-authorized for payment by the customer.

10. The method of bank security in online commerce as in claim 9, comprising:
maintaining in the pre-authorized transaction list, payment transactions by at least the dollar amount and then optionally a payee name.

11. The method of bank security in online commerce as in claim 9, comprising:
enabling the mobile device owner with a secure interface that enables the mobile device owner, to create and maintain the pre-authorized transaction list.

12. The method of bank security in online commerce, as in claim 9, comprising:
authorizing by the MAS system payment on those payment authorization request transactions that are on the pre-authorized transaction list and for those transaction that are not on the list, authorizing the transaction by a secure mobile contact means with the customer, thereby reducing payment on transaction that have not been authorized and thus reducing bank's fraud losses.

13. The method of bank security in online commerce, as in claim 12, comprising:
including among the secure contact means, a plurality from a group of (i) SMS on mobile device, (ii) telephone call on a mobile device, (iii) e-mail on a mobile device, where the contact information is pre-maintained in a mobile contact database.

14. The method of bank security in online commerce, as in claim 13, comprising:
having a secure means in the mobile device to respond to the authorization request on the mobile device.

15. A system of bank security for reducing fraud losses due to unauthorized transactions in online commerce, comprising:
a. databases that maintain account information for bank customers and computer systems on the electronic fund transfer network for receiving a payment authorization request and authorizing real time payment transactions on the customer's bank accounts maintained in the databases;
b. a pre-authorized transaction list database, which maintains a list of payment transactions by payee and dollar amount that have been pre-authorized by the bank customer, where upon receiving a payment authorization request, if the requested transaction is present in the pre-authorized list that provides an added means of security for the bank before authorizing the specific payment on the pre-authorized list on the account.

16. The system of bank online transaction security as in claim 15, comprising:
a secure means for the bank customer to create and maintain the pre-authorized list in the bank's computer systems.

17. The system of bank online transaction security as in claim 15, comprising:
a secure contact means between the bank and the bank customer;
for those payment authorization requests that are not on the pre-authorized transaction list, establishing a contact via the secure contact means with the bank customer to seek authorization for the payment authorization request that is not on the list.

18. The system of bank online transaction security as in claim 17, comprising:
the bank authorizes payment on those payment authorization request transactions that are on the pre-authorized transaction list and for those transaction that are not on the list, the transaction is authorized by the secure contact means, thereby reducing payment on transaction that have not been authorized and thus reducing bank's fraud losses.

19. The system of bank online transaction security as in claim 17, comprising:
the secure contact means include a plurality from a group of (i) SMS on mobile device, telephone call on a mobile device, e-mail on a mobile device, where the contact information is pre-maintained in a mobile contact database.

20. The system of bank online transaction security as in claim 19, comprising:
a secure means in the mobile device to respond to the authorization request on the mobile device.
